(19) United States
(12) Patent Application Publication
(10) Pub. No.: US 2003/0021278 A1
(43) Pub. Date: Jan. 30, 2003

(54) Method for setting up telecommunications connections in the access area of local access, subscriber connection system, local access and remote equipment

(75) Inventors: Peter Domschitz, Stuttgart (DE); Thomas-Rolf Banniza, Schwieber-Dingen (DE)

Correspondence Address: SUGHRUE MION, PLLC, 2100 PENNSYLVANIA AVENUE, N.W., WASHINGTON, DC, 20037, US

(73) Assignee: ALCATEL

(21) Appl. No.: 10/200,218

(22) Filed: Jul. 23, 2002

(30) Foreign Application Priority Data
Jul. 27, 2001 (EP) 01 440 241.6

(51) Int. Cl. H04L 12/28; H04L 12/66

(52) U.S. Cl. 370/395.2; 370/352; 709/203; 209/229

(57) ABSTRACT

The invention relates to a method for setting up telecommunications connections, in particular packet-switched telecommunications connections, in the access area (SN, LM) of a local access (ER) comprising the following steps:

acceptance of a request for setting up a telecommunications connection from or to an end subscriber (TE) by the local access (ER),

checking by the local access (ER) of whether said end subscriber (TE) is authorized to set up the required telecommunications connection,

setting up of a channel individually for the connection as part of a medium common to a plurality of subscribers between the local access (ER) and remote equipment (AP, MR),

signalling of the request for setting up a telecommunications connection by the local access (ER) to the remote equipment (AP, MR),

acceptance of the signalling by the remote equipment (AP, MR),

connection of a subscriber-specific path from the remote equipment (AP, MR) to the end subscriber (TE) to the channel, set up individually for the connection, that is part of a medium common to a plurality of subscribers between the local access (ER) and the remote equipment (AP, MR) by the remote equipment (AP, MR), and

reception of the desired telecommunications connection,

and also a subscriber connection system, a local access (ER), remote equipment (AP, MR) and a program module.

### BACKGROUND OF THE INVENTION

The invention is based on a priority application EP 01 44 0241 which is hereby incorporated by reference.

The invention relates to a method for setting up telecommunications connections, in particular packet-switched telecommunications connections, in the access area of a local access, a subscriber connection system in the access area of a local access, a local access and remote equipment.

### SUMMARY OF THE INVENTION

Conventional telecommunications networks are hierarchical in structure. The closest subscriber switching node, the local access, was (and also currently still is) responsible at the some time for subscriber service. Most intelligence in the telecommunications network was therefore established there.

An essential part of subscriber service is billing. This is not, however, technically obligatory and is also not provided for all subscriber connections; exceptions are, for example, emergency telephones. Conversely, the checking of subscriber authorization is technically obligatory. Public telephones, including emergency telephones, may be used, for example, in some countries only for outgoing calls. On the other hand, only very defined destinations may, as a rule, be called from emergency telephones. Since fairly large cash amounts are difficult to collect, public telephones are often permitted only for local or inland calls.

In the meantime, very different types of telecommunications connections, particularly also those having different capacity requirements, are also routed via the public telecommunications network, the same paths still having to be taken at least up to the subscriber service. Here, the checking of subscriber authorization is a very essential feature of setting up a connection. Checking whether the calling or called subscriber is technically in fact capable of conducting a communications connection of the type mentioned is regarded as part of checking subscriber authorization.

For many new types of communications connections, the capacity of a standard voice channel having (in Europe) 64 kbit/s is inadequate, in some cases by far. Communications connections having markedly higher capacity cannot, however, be conducted without difficulty over the same distances as those known for subscriber connections in the area of conventional local accesss.

The object of the invention is to provide a solution to the problem revealed above.

According to the invention, this object is achieved by a method according to the teaching of claim 1, a subscriber connection system according to the teaching of claim 2, a local access according to the teaching of claim 3 and remote equipment according to the teaching of claim 4.

The remote equipment is consequently upgraded to an active distribution network in which simple switching tasks take place; the subscriber service remains, however, in the local access and is, consequently, no longer in the nearest subscriber switching node.

Further refinements of the invention are to be found in the subclaims and in the description below.

### BRIEF DESCRIPTION OF THE DRAWINGS

The invention is further explained below with the aid of the accompanying drawings:

FIG. 1 shows diagrammatically an exemplary embodiment of a subscriber connection system according to the invention for performing the method according to the invention having a local access according to the invention and some items of remote equipment according to the invention.

FIG. 2 shows, in somewhat more detail, a portion of a further exemplary embodiment of a subscriber connection system according to the invention that has been modified with respect to the exemplary embodiment according to FIG. 1 in such a way that it has two local accesss according to the invention.

FIG. 3 shows a further exemplary embodiment of a subscriber connection system according to the invention.

FIG. 4 shows further details relating to a subscriber connection system according to the invention.

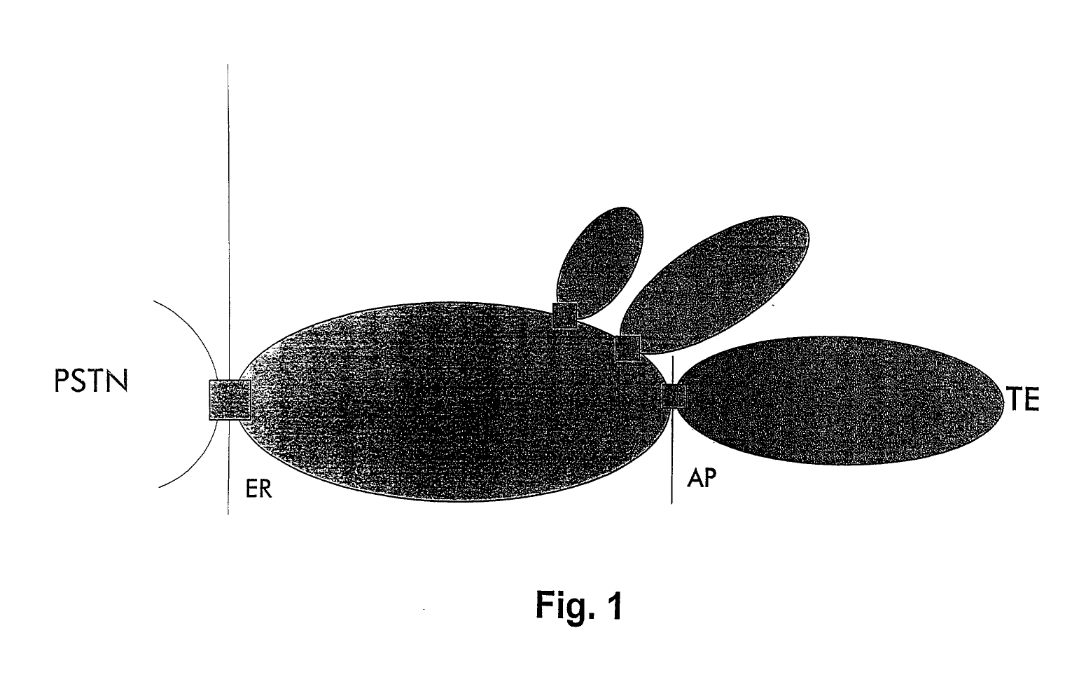

The basic idea of the invention is first explained using FIG. 1. The figure shows three hierarchy areas of a telecommunications network that are separated from one another by vertical lines. Here, the public PSTN area is shown on the far left. PSTN (public switching telephone network) is used quite generally as a description of the generally accessible part of the ultimately one worldwide telecommunications network. Connected thereto is the subscriber access area that, as a consequence of the invention, is again divided up into two hierarchical stages. These two sections relate to an operating section SN and an access section LM. Here, a single end subscriber TE is shown at the access section LM as representative of many. Shown between the areas is, on the one hand, a local access ER and, on the other hand, remote equipment AP. Indicated at the periphery of the operating section SN are further items of remote equipment having further access sections LM.

Here, terms are used, some of which (local access, remote equipment) originate from conventional switching technology and are possibly also encumbered with other contents from that source and some of which (operating section, access section) are terms that do not in themselves say anything and where there is no fixed language usage. The abbreviations ER, SN, AP and LM refer to the working title. The local access ER is designated internally as “edge router”, and the remote equipment AP as “access point”. The operating section SN is correspondingly designated as “serving network” and the access section LM as “last metre access”.

These internal designations completely reflect the invention in a certain way. With regard to more modern technologies, in which packet switching plays a weighted part, the traditional term switching is preferably replaced by the term “routing”. The termination (“edge”) of the public network PSTN and the termination (“access”) of the subscriber-specific area no longer coincide here according to the invention; in between there is a further network section SN, which serves both sides as an extension. The “last-mile” area known in the meantime has now become a “last-metre” area for technological reasons and is typically the last 300 m.

In the access section, inter alia for data protection reasons, individual subscriber paths continue to be necessary from the outset even though these may vary completely in their capacity compared with traditional paths.

Simply because of the variable capacities in the access section, and really because of the variable capacities in a plurality of access sections, simple multiplex-type combinations of the individual subscriber-specific data streams no longer take place in the intervening area, in this case the operating section SN. On the other hand, in this case, only a small proportion of active and intelligent devices can be provided simply because, in this area, all the devices are no longer situated in fixed buildings and cannot be provided with a separate power supply either. The invention therefore envisages forming, in the first section of the remote equipment, the operating section SN, an active distribution network in which simple switching tasks—designated as routing tasks in packet switching—take place, whereas the subscriber service, in particular the authorization checking, takes place in the local access, the “edge router” ER. Consequently, in contrast to conventional networks, the subscriber service no longer takes place in the nearest subscriber switching node, the “access point” as remote equipment AP.

Connected in a certain way to the authorization check, is the question of quality assurance in the case of connections in progress, also known under the keyword “quality of service, QoS”. Here, the authorization is not checked for an individual connection, but for every individual part thereof, that is to say for every individual data packet. This is a task that necessarily has to take place without constant access to any subscriber data and can therefore be separated from the abovementioned authorization check and, for that reason, can also be performed in the remote equipment in the nearest subscriber switching node.

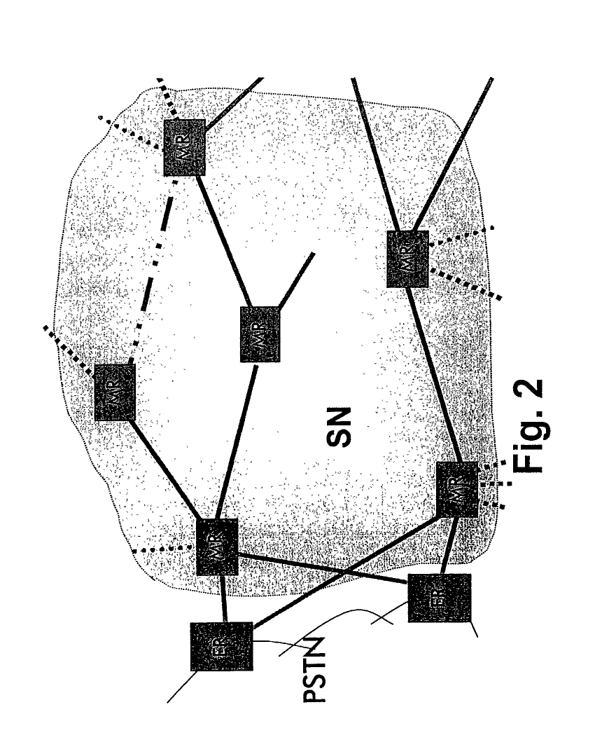

FIG. 2 shows an example of an operating section SN in which, by way of example, the variable capacity requirements of the individual subscribers are particularly taken into account. The items of remote equipment are here, in contrast to the “edge routers”, designated as “micro routers” MR. In order to conduct variable traffic, they are, at least partly, intermeshed in order to compensate for unequal loads even though a sufficiently large number of direct connections to the local access each having inherently a very large capacity, for example glass fibres, would provide a comparable result. The same could also be achieved with a tree structure, in this case MR, whether with or without items of remote equipment AP according to the invention. In addition, said remote equipment is connected not only to a single local access ER, but to two thereof in the example. Of course, each of the two local access ER must then be capable of performing the subscriber service for all the subscribers connected to said remote equipment. However, the access necessary for this to a common service means is problem-free.

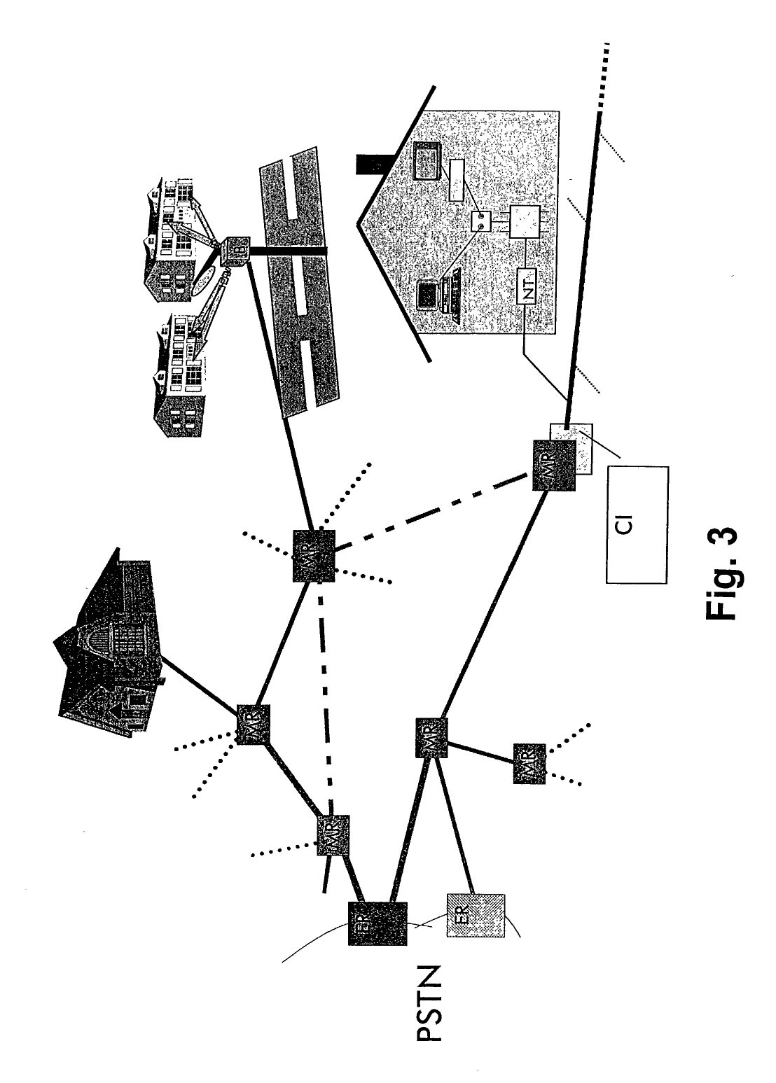

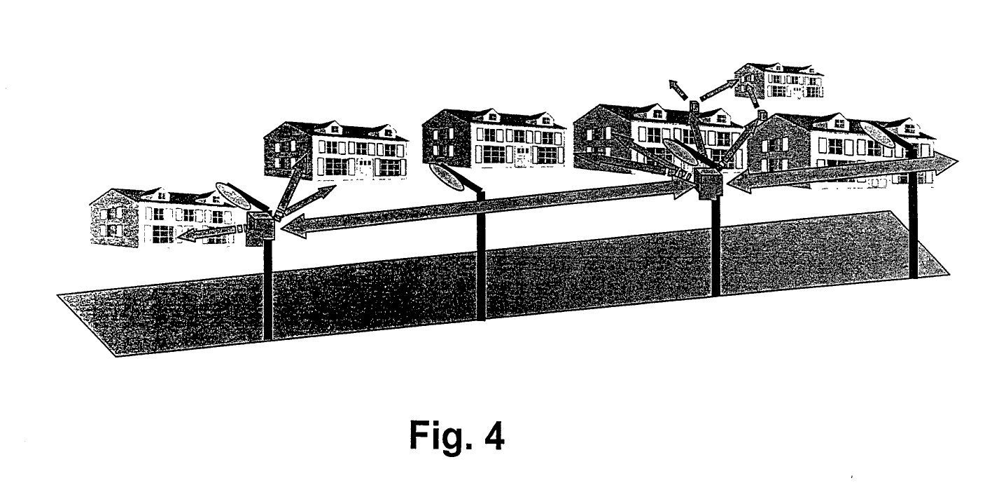

FIG. 3 shows, as does FIG. 4, another aspect of the invention namely the variety of the network elements that can be used here. In the operating section between the local access, in this case ER, and the items of remote equipment, in this case MR, and also mutually between the items of remote equipment, glass fibre sections are mainly suitable as a medium common to a plurality of subscribers. Radio connections or coaxial-cable connections are, however, not basically excluded either. The standards used (high-speed LAN, Ethernet, PCM 30/32) do not play any basic role here either.

In the access section, thought is given here, inter alia, to a broadband connection via coaxial cable from the bottom right in FIG. 3. Here, a coaxial-cable interface CI is provided on the remote-equipment side MR and a network termination appliance (“network termination”) is provided on the subscriber side. On the premises of the subscriber himself, a distributor, a connection socket, a PC and a television set connected via a connection circuit are shown. Such connection circuits for television sets are normally designated nowadays as “set-top boxes”.

The example at the top right in FIG. 3 shows a connection via a base station B, which may itself be equipped yet again as remote equipment, with a micro-router. Suitable as a medium for the connection of the subscribers to said base station are fixed radio connections, and under some circumstances also optical connections, both designated as “fixed wireless”.

The example at the top in the centre of FIG. 3 shows a connection of an individual subscriber via connection types to be designated nowadays even as conventional, such as copper twin core or glass fibre. The copper twin core, a so-called twisted-pair line, is operated, for example, in one of the XDSL operating modes, DSL stands in this case for “digital subscriber line”, the X stands for a different known variant. If a glass fibre is used, a FTTH (FTTH=fibre to the home) technology is applied.

FIG. 4 shows further variants at the junction between operating section and access section and within the access section. Here base stations comprising micro-routers are mounted on individual illumination masts along a street and are mutually interconnected along the street via free optical connecting sections, so-called free space optics. The connection to the local access is not shown here. The connection to the subscribers themselves takes place over sections having optical line of sight either via radio in the range of about 40 . . . 60 GHz or alternately via light beams. Individual remote stations may serve exclusively or additionally as relays so that some subscribers can be reached only via relays. Over these short sections, a simple and inexpensive technology can always be applied. Suitable as types of modulation are, for example, FSK or DQPSK. Because of the low power necessary, cheap power amplifiers are adequate; the street illumination can be concomitantly used for the power supply by charging up storage batteries of suitable capacity during the night. Consequently, the associated costs for the installation are also very low.

Of course, the control and signalling means also have to be adapted to the mode of operation described in the above-described network elements. However, this is possible with the known means as soon as it is understood. The necessary programs and program modules can then also readily be produced. The known principles relating to path selection can basically be used for the path selection now also necessary in the remote equipment.

1. Method for setting up telecommunications connections, in particular packet-switched telecommunications connections, in the access area of a subscriber access comprising the following steps:
acceptance of a request for setting up a telecommunications connection from or to an end subscriber by the local access,
checking by the local access of whether said end subscriber is authorized to set up the required telecommunications connection,
setting up of a channel individually for the connection as part of a medium common to a plurality of subscribers between the local access and remote equipment,
signalling of the request for setting up a telecommunications connection by the local access to the remote equipment,
acceptance of the signalling by the remote equipment,
connection of a subscriber-specific path from the remote equipment to the end subscriber to the channel, set up individually for the connection, that is part of a medium common to a plurality of subscribers between the local access and the remote equipment by the remote equipment, and
reception of the desired telecommunications connection.

2. Subscriber access system in the access area of a local access, comprising
first control means in the local access for the acceptance of a request for setting up a telecommunications connection from or to an end subscriber by the local access,
second control means in the local access for checking whether said end subscriber is authorized for setting up the desired telecommunications connection,
first coupling means for setting up a channel selected individually for the connection as part of a medium common to a plurality of subscribers between the local access and remote equipment
first signalling means for signalling the request for setting up the telecommunications connection by the local access to the remote equipment,
second signalling means for the acceptance of the signalling by the remote equipment, and
second coupling means for the connection of a subscriber-specific path
from the remote equipment to the end subscriber using the channel, set up individually for the connection, that is part of a medium common to a plurality of subscribers between the local access and the remote equipment by the remote equipment.

3. Local access, comprising
first control means for the acceptance of a request for setting up a telecommunications connection from or to an end subscriber,
second control means for checking whether said end subscriber is authorized for setting up the desired telecommunications connection,
first coupling means for setting up a channel individually for the connection as part of a medium common to a plurality of subscribers between the local access and the remote equipment, and
first signalling means for signalling the request for setting up the telecommunications connection to the remote equipment by the local access.

4. Remote equipment, comprising
second signalling means for the acceptance of the signalling of a request for setting up a telecommunications connection from or to an end subscriber, and
second coupling means for the connection of a subscriber-specific path from the remote equipment to the end subscriber to a channel, set up individually for the connection, that is part of a medium common to a plurality of subscribers between a local access and remote equipment.

5. Method according to claim 1, in the course of setting up the channel individually for the connection, a check being first made on whether a path selection is possible to said end subscriber and in that if a path selection possibility exists, one of the possible paths is first selected.

6. Subscriber connection system according to claim 2, third control means being present in the local access for checking whether a path selection is possible to said end subscriber and for the selection of one of the possible paths if a given path selection possibility exists.

7. Local access according to claim 3, having third control means for checking whether a path selection is possible to said end subscriber and for the selection of one of the possible paths if a path selection possibility exists.

8. Program module for performing a method for setting up telecommunications connections, in particular packet-switched telecommunications connections, in the access area of a local access having program elements for controlling the following steps:
acceptance of a request for setting up a telecommunications connection from or to an end subscriber by the local access,
checking by the local access of whether said end subscriber is authorized for setting up the desired telecommunications connection,
setting up of a channel individually for the connection as part of a medium common to a plurality of subscribers between the local access and remote equipment,
signalling of the request for setting up the telecommunications connection to the remote equipment by the local access,
acceptance of the signalling by the remote equipment,
connection of a subscriber-specific path from the remote equipment to the end subscriber to the channel, set up individually for the connection, that is part of a medium common to a plurality of subscribers between the local access and the remote equipment by the remote equipment, and
reception of the desired telecommunications connection.
